(19) United States
(12) Patent Application Publication
(10) Pub. No.: US 2018/0111426 A1
(43) Pub. Date: Apr. 26, 2018

(54) CABLE BEAD FOR PNEUMATIC TIRE AND PNEUMATIC TIRE HAVING THE SAME

(71) Applicant: KUMHO TIRE CO., INC., Gwangju (KR)

(72) Inventors: Byung Chul PARK, Yeosu-si (KR); Woo Young KIM, Incheon (KR)

(21) Appl. No.: 15/672,912

(22) Filed: Aug. 9, 2017

(30) Foreign Application Priority Data
Oct. 26, 2016 (KR) 10-2016-0140390
Dec. 22, 2016 (KR) 10-2016-0176557

(51) Int. Cl. B60C 15/04

(52) U.S. Cl. CPC B60C 15/04; D02G 3/48; B60C 2015/046

(57) ABSTRACT

The present disclosure relates to a cable bead for a pneumatic tire which constitutes a bead part of a pneumatic tire, improves rubber permeability by restricting a ratio between a diameter of a cable and a pitch of an outer wire, and improves durability of a pneumatic tire by improving rubber adhesive properties through cobalt coating on a surface of the outer wire, and a pneumatic tire having the same, and the cable bead for a pneumatic tire is characterized in that the diameter D of the cable and a pitch P of the outer wire 20 satisfy a relationship formula, P/D=25 to 45, and further characterized in that the surface of the outer wire 20 is coated with cobalt after wire drawing.

### CROSS-REFERENCE TO RELATED APPLICATIONS

This application claims the benefit and priority of Korean Patent Application No. 10-2016-0176557 filed Dec. 22, 2016 and Korean Patent Application No. 10-2016-0140390 filed Oct. 26, 2016. The entire disclosures of the above applications are incorporated herein by reference.

### Field

The present disclosure relates to a cable bead for a pneumatic tire which constitutes a bead part of a pneumatic tire, and a pneumatic tire having the same, and more particularly, to a cable bead for a pneumatic tire which improves rubber permeability by restricting a ratio between a diameter of a cable and a pitch of an outer wire, and improves durability of a pneumatic tire by improving rubber adhesive properties through cobalt coating on a surface of the outer wire, and a pneumatic tire having the same.

### Background

This section provides background information related to the present disclosure which is not necessarily prior art.

In general, a pneumatic tire includes a tread which comes into contact with a road surface, a carcass which constitutes a framework of the tire, a belt part which is installed between the tread and the carcass, an inner liner which prevents a leakage of air, a sidewall which protects the carcass and flexibly bends and stretches, and a bead part which allows the tire to be mounted to a rim.

Here, the bead part is an important part which supports a load of a vehicle by fixing the tire to the rim of the vehicle, transmits rotational force of an axle to the tire, and maintains a balance of a vehicle body by absorbing shocks from the ground surface. Further, the bead part has strands of wires configured by steel cords, and serves to mount and fix the tire to the rim. In addition, the bead part serves to fix a carcass cord for supporting air pressure in the tire and supporting force that bends and stretches the tire when the vehicle travels. In particular, in a tubeless tire, the bead part of the tire serves to prevent a leakage of air between the tire and a rim of a wheel, and the rim of the wheel is formed to coincide with a mounting position of the bead and thus serves as a support body for the tire bead.

Therefore, the bead part needs to have high rigidity. To this end, the bead, which constitutes the bead part, is made by using wires having rigidity of about 280 to 320 kg/cm², and the bead is classified into a tape bead and a cable bead depending on an arrangement form of the wires that constitute the bead.

The tape bead is formed by cutting a bead strip, which is made by arranging a plurality of strands of wires in parallel and covering the wires with a rubber layer, to a tape shape having a predetermined width and a predetermined thickness. Further, the cable bead is formed by twisting and winding, several times, a strand of an outer wire around an outer circumferential surface of a core wire, or twisting and winding, several times, a strand of an outer wire around an outer circumferential surface of a core wire and then twisting and winding, several times, a strand of another outer wire outside the outer wire.

The cable bead has no weight difference between portions in a circumferential direction of the bead, and stress is concentrated at the tape bead, which is manufactured by using the plurality of strands of wires, due to a level difference between a start point and an end point. In contrast, the cable bead is advantageous in improving durability because the core wire is joined by welding without a level difference of the wire, the single strand of wire is twisted and wound, several times, around the core wire, and then an end of the core wire is finished by a clip.

Further, the cable bead is formed by using a plurality of steel cores, and thus suitable to ensure transmission of braking torque and traction torque applied to the tire from the rim while the vehicle accelerates or decelerates, and to prevent the tire from slipping relative to a mounting rim for fixing the tire to the rim, and as a result, the cable bead is used instead of the tape bead or a single winding bead.

However, unlike the single bead or the tape bead in which the wires are coated with rubber and then formed as a bundle of wires, the cable bead in the related art is configured such that one or more wires are twisted and wound around the core wire to form a bundle of steel cords, and then the bundle of steel cords is coated with rubber, and as a result, there is a problem in that the respective wires are not perfectly coated with rubber.

In a case in which the wires, which constitute the cable bead, are not appropriately coated with rubber as described above, heat may be generated due to friction between the wires made of metal, and the wires and the rubber may be abraded due to friction, such that durability of the cable bead and the pneumatic tire may deteriorate. In addition, when the tire is exposed to a wet environment, the wire, which is exposed to the outside as the rubber removed, is corroded due to moisture, and as a result, durability of the cable bead and the pneumatic tire may deteriorate.

Meanwhile, a plurality of patent documents has been found as a result of searching for the related arts associated with the present disclosure, and some patent documents will be described below.

Patent Document 1 discloses a mixed layered cable which includes a nonmetallic inner layer, and an unsaturated outer layer including strands which are at least partially made of metal and wound in a spiral shape around the inner layer, in which the cable has a relative elongation percentage At when the cable is broken over 7% when the cable is subjected to measurement with tensile force in accordance with standard ISO 6892 established in 1984. Some cables may be used to reinforce at least one crown protection ply of the tire which is mounted to a large-sized vehicle or heavy equipment, and the others may be used to reinforce the tire bead of a lightweight motor vehicle such as a motor cycle.

Patent Document 2 discloses a cable bead for a tire which is formed by twisting and winding, several times, an outer wire around an outer circumferential surface of a core wire, in which end portions of the outer wire are connected by welding by using a clip, and the welding is applied to contact surfaces at both ends of the outer wire, contact surfaces between the clip and the outer wire, and contact surfaces of an upper end surface and a lower end surface of the clip, such that the end portions of the outer wire are connected by welding by using the clip, and as a result, tensile strength of the connection portions is increased to about 90±10% of tensile strength of a basic material, such that durability of the connection portions is increased after the tire is manufactured.

### DOCUMENT OF RELATED ART

### Patent Document

(Patent Document 1) KR10-1014546 B1

(Patent Document 2) KR10-1435285 B1

### SUMMARY

This section provides a general summary of the disclosure, and is not a comprehensive disclosure of its full scope or all of its features.

The present disclosure has been made in an effort to provide a cable bead for a pneumatic tire in which a pitch of an outer wire is determined in consideration of a diameter of a cable, such that rubber permeability to a core wire is improved, heating and abrasion caused by friction between metals are prevented, and thus durability is improved, and a pneumatic tire having the same.

The present disclosure has also been made in an effort to provide a cable bead for a pneumatic tire in which rubber adhesive properties of an outer wire are improved, corrosion of the outer wire in a wet environment is inhibited, and thus corrosion resistance is improved, and a pneumatic tire having the same.

An exemplary embodiment of the present disclosure provides a cable bead for a pneumatic tire, which is applied to a bead part of the pneumatic tire and formed by twisting and winding one or more outer wires around a core wire and has a cable including the outer wires and the core wire, in which a diameter D of the cable and a pitch P of the outer wire satisfy a relationship formula, P/D=25 to 45.

According to the cable bead for a pneumatic tire, a diameter dₒ of the outer wire may be 25 to 75% of a diameter d of the core wire, and six to fifteen outer wires may be wound around a single core wire.

According to the cable bead for a pneumatic tire, the outer wire may be wound around the core wire in any one of a right-winding manner or a left-winding manner.

According to the cable bead for a pneumatic tire, a surface of the outer wire may be coated with cobalt after wire drawing.

According to the cable bead for a pneumatic tire, the cobalt coating may be performed on the outer wire at a ratio of cobalt 0.4 to 1.2 mg for the outer wire 1 kg, namely at a ratio of 0.4 to 1.2 mg/kg.

According to the cable bead for a pneumatic tire and the pneumatic tire having the same according to the present disclosure, a clearance is present between the outer wires by determining a relationship between the diameter of the cable and the pitch of the outer wire when configuring the cable bead, and as a result, permeability of the rubber is improved, and heating and abrasion caused by friction between metals are prevented, thereby improving durability.

According to the cable bead for a pneumatic tire and the pneumatic tire having the same according to the present disclosure, the cobalt coating layer is formed on the surface of the outer wire, and as a result, rubber adhesive properties are improved, and thus the outer wire is not corroded even though the outer wire is exposed to a wet environment, thereby improving durability.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a configuration view illustrating a cable bead for a pneumatic tire according to the present disclosure;

FIG. 2 is a cross-sectional view of the cable bead for a pneumatic tire of the present disclosure;

FIG. 3 is a cross-sectional view illustrating a pitch of an outer wire of the cable bead for a pneumatic tire of the present disclosure; and

FIG. 4 is a reference view illustrating twisted shapes of the cable bead for a pneumatic tire of the present disclosure.

Corresponding reference numerals indicate corresponding parts or features throughout the several views of the drawings.

### DETAILED DESCRIPTION

Example embodiments will now be described more fully with reference to the accompanying drawings.

Hereinafter, a cable bead for a pneumatic tire of the present disclosure will be described below with reference to the accompanying drawings.

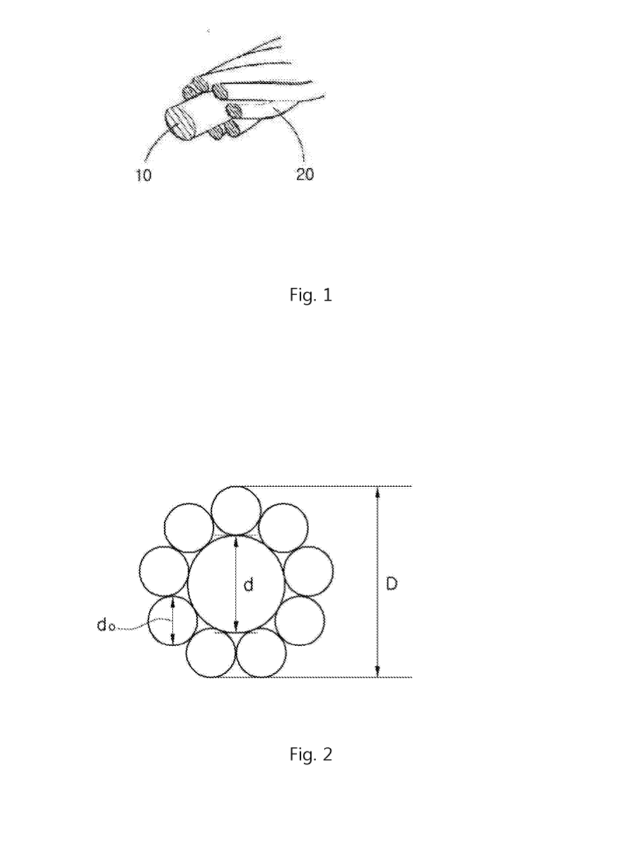

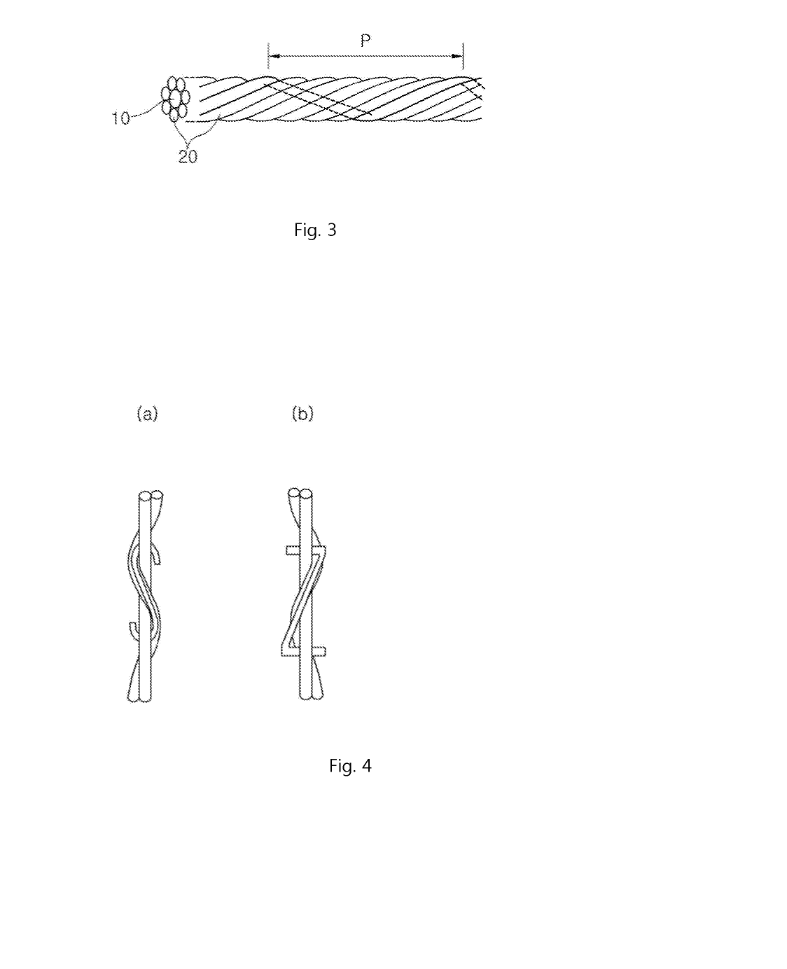

The cable bead for a pneumatic tire according to the present disclosure is applied to a bead part for a pneumatic tire, and as illustrated in FIG. 1, the cable bead is formed by twisting and winding one or more outer wires 20 around a core wire 10.

In this case, preferably, a diameter D of the cable and a pitch P of the outer wire 20 may satisfy a relationship formula, P/D=25 to 45. The reason is that in a case in which P/D is below 25, the outer wire 20 is excessively bent such that an air gap between the core wire 10 and the outer wire 20 is irregular and thus the outer wire 20 is unstably twisted, and in a case in which P/D is above 45, a line contact surface of the outer wire is increased such that rubber does not easily permeate.

Further, a diameter dₒ of the outer wire 20 is 25 to 75% of a diameter d of the core wire 10, and preferably, 40 to 60% of the diameter d of the core wire 10. Six to fifteen outer wires 20 may be wound around the single core wire 10. The reason is that in a case in which the diameter dₒ is below 25% of the diameter d, the number of outer wires 20 needs to be increased to implement a reinforcement effect by the outer wires 20 and the outer wire 20 is likely to be broken by impact, and in a case in which the diameter dₒ is above 75% of the diameter d, a diameter D of the cable including the core wire 10 and the outer wires 20 may be excessively increased.

In a case in which the pitch P of the outer wire 20 is determined depending on the diameter D of the cable as described above, a clearance is formed between the outer wires 20, and as a result, the rubber easily permeates.

To verify an effect of the relationship formula, P/D=25 to 45, a breathability test capable of checking rubber permeability was carried out. Typically, the breathability test is a test method which compares rubber permeability of steel cords, and measures time elapsed until air passes through a test material when covering the test material with rubber, vulcanizing the rubber, and then applying air pressure to one end of the test material.

In the present test, a plurality of samples was manufactured while changing a value of P/D, and rubber permeability was checked through the breathability test and evaluation for each specimen, and as a result, a result as shown in Table 1 was obtained.

TABLE 1

| | Com- | | | | | Com- |
|---|---|---|---|---|---|---|
| | parative | Ex- | Ex- | Ex- | Ex- | parative |
| Classifi- | Example | ample | ample | ample | ample | Example |
| cation | 1 | 1 | 2 | 3 | 4 | 2 |
| P/D | 22 | 32 | 35 | 40 | 45 | 47 |
| Sample 1 | 1.97 | 9.53 | 13.22 | 10.35 | 9.49 | 3.56 |
| Sample 2 | 1.27 | 10.94 | 10.85 | 11.92 | 9.21 | 4.21 |
| Sample 3 | 1.30 | 10.23 | 11.32 | 12.21 | 8.99 | 3.32 |
| Average | 1.51 | 10.23 | 11.79 | 11.49 | 9.23 | 3.70 |
| (second/ | | | | | | |
| 100 ml) | | | | | | |

Referring to Table 1, in Example 1 and Example 2 which belong to the scope of the present disclosure and have P/D values of 32 and 35, respectively, the average values were 10.23 seconds and 11.79 seconds, and as a result, a satisfactory breathability test result was confirmed. In Comparative Example 1 in which the P/D value was 22 which is below a lower limit value, the time elapsed until air passes was 1.51 seconds in average which is extremely small, and in Comparative Example 2 in which the P/D value was 47 which is above an upper limit value, the time was 3.7 seconds in average, such that the time elapsed until air passes is increased in comparison with Comparative Example 1, but it was confirmed that the time was incomparably smaller than those in Examples.

Meanwhile, a surface of the outer wire 20 may be coated with cobalt after wire drawing. In this case, the cobalt coating is performed on the outer wire 20 at a ratio of 0.4 to 1.2 mg/kg, more particularly, 0.8 to 0.9 mg/kg. The reason is that in a case in which the cobalt coating was performed on the outer wire 20 at a ratio of below 0.4 mg/kg, an effect was inadequate, and in a case in which the cobalt coating was performed on the outer wire 20 at a ratio of 1.2 mg/kg or more, an effect was not increased any further. Further, the cobalt coating on the outer wire 20 serves to improve wet aging adhesive properties of the rubber.

To verify an effect of the cobalt coating, a wet heat adhesive force evaluation test, which is a test for checking a change in adhesive force after the outer wire has aged due to an environment, was carried out. In the wet heat adhesive force evaluation test, after the cord and the rubber were vulcanized together, and then left unattended under a condition of 80° C. and R.H 85% for three or more weeks, an attachment ratio between the cord and the rubber was investigated, and a result thereof is as shown in the following Table 2. In Table 2, the attachment ratios between the cord and the rubber in the multiple examples, in which the amount of cobalt coating is changed based on Comparative Example 1 (100%), are indicated by comparison indexes %.

Referring to Table 2, it was confirmed that an effect was realized when the amount of cobalt coating is 0.4 mg/kg, and the effect was consistently maintained even though the amount of cobalt coating exceeds 1.2 mg/kg.

TABLE 2

| | Comparative | Comparative | Example | Example | Example | Example | Example | Example |
|---|---|---|---|---|---|---|---|---|
| Classification | Example 1 | Example 2 | 1 | 2 | 3 | 4 | 5 | 6 |
| Amount of Cobalt | 0 | 0.3 | 0.4 | 0.5 | 0.59 | 0.87 | 1.2 | 1.5 |
| (mg/kg) | | | | | | | | |
| Wet Heat 3-Week | 100% | 100% | 105% | 110% | 117% | 128% | 129% | 129% |
| Attachment Index | | | | | | | | |
| (%) | | | | | | | | |

In the related art, a plating layer is formed on the surface of the outer wire by copper plating or zinc plating, but the copper plating layer or the zinc plating layer is easily corroded due to moisture, and acts as a factor that decreases adhesive force between the rubber and the outer wire due to excessive growth of an adhesive layer caused by moisture. Therefore, the cobalt coating layer, which is capable of preventing the deterioration of the adhesive layer caused by moisture, is formed to improve age-adhesive force due to wetting of the outer wire, and to improve corrosion resistance of the wire.

Further, in order to verify an effect of the cobalt coating layer, the cable beads were manufactured as follows in accordance with Example and Comparative Example, adhesive force indexes and rubber attachment ratios were checked over time, and the results are as shown in Tables 3 and 4.

### EXAMPLE

The cable bead has a structure of 1*3.0+10*1.30, the diameter D is 5.6 mm, the pitch P of the outer wire is 163 mm, and the outer wire is coated with cobalt so as to have a cobalt content of 0.87 mg/kg.

### COMPARATIVE EXAMPLE

The cable bead, which is identical to that of Example, is manufactured, but the cobalt coating process is omitted, such that the outer wire does not have a cobalt content.

Referring to Tables 3 and 4, it can be seen that in Comparative Example, the adhesive force index and the rubber attachment ratio are continuously decreased as time passed. However, it can be seen that in Example, the adhesive force index and the rubber attachment ratio are significantly decreased at the initial time, but a decrease rate is gradually decreased after predetermined time has elapsed, and as a result, the adhesive force index and the rubber attachment ratio are excellent in comparison with Comparative Example.

Further, 205/60R 16 tires were manufactured by using the cable beads according to Example and Comparative Example, and the finished product tires were piled up in open air in a state of being left unattended for one month, and stored in a wet heat chamber (85° C., 85% RH) condition for one month, and then a tire durability experiment was carried out, and durability indexes according to the experimental result are as shown in the following Table 5.

TABLE 5

| Classification | Comparative Example | Example |
|---|---|---|
| Normal Condition | 100% | 100% |
| One-month Piled Up | 100% | 110% |
| One-month Wet Heat | 100% | 126% |
| Chamber | | |

The durability (%) shown in Table 5 shows, as a percentage (%), time elapsed until the bead part of the tire is broken, which is increased in comparison with Comparative Example, in accordance with evaluation of load durability of the bead part, and it can be seen that durability in Example is excellent by about 10 to 26% in an environment aging condition in comparison with Comparative Example.

While several exemplary embodiments for explaining the technical spirit of the present disclosure have been described and illustrated as described above, it will be well understood by those skilled in the art that the present disclosure is not limited to the configurations and the operations as described above, but the present disclosure may be variously changed and modified without departing from the scope of the technical spirit disclosed in the specification. Therefore, all of the appropriate changes, modifications, and equivalents thereto should be considered as being included in the scope of the present disclosure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A cable bead for a pneumatic tire, which is applied to a bead part of the pneumatic tire, formed by twisting and winding one or more outer wires 20 around a core wire 10 and has a cable including the outer wires 20 and the core wire 10, wherein a diameter D of the cable and a pitch P of the outer wire 20 satisfy a relationship formula, P/D=25 to 45.

2. The cable bead according to claim 1, wherein a diameter dₒ of the outer wire 20 is 25 to 75% of a diameter d of the core wire 10, and six to fifteen outer wires 20 are wound around the core wire 10.

3. The cable bead according to claim 1, wherein the outer wires 20 are wound around the core wire 10 in any one of a right-winding manner or a left-winding manner.

4. The cable bead according to claim 1, wherein a surface of the outer wires 20 are coated with cobalt after wire drawing.

5. The cable bead according to claim 4, wherein the cobalt coating is performed on the outer wires 20 at a ratio of 0.4 to 1.2 mg/kg.

6. A pneumatic tire to which the cable bead according to claim 1 is applied.

7. A pneumatic tire to which the cable bead according to claim 2 is applied.

8. A pneumatic tire to which the cable bead according to claim 3 is applied.

9. A pneumatic tire to which the cable bead according to claim 4 is applied.

10. A pneumatic tire to which the cable bead according to claim 5 is applied.
